(19) United States
(12) Patent Application Publication
(10) Pub. No.: US 2005/0261962 A1
(43) Pub. Date: Nov. 24, 2005

(54) Anonymous page recognition

(76) Inventor: Khai Gan (Kenneth) Chuah, Austin, TX (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/132,079

(22) Filed: May 18, 2005

Related U.S. Application Data
(60) Provisional application No. 60/572,042, filed on May 18, 2004.

(51) Int. Cl. G06F 17/60

(52) U.S. Cl. 705/14

(57) ABSTRACT

A data mining system to improve selection of targeted advertisements. The system includes monitoring, capturing, and analyzing data from a user, and selecting appropriate advertisements to match a current user's activity.

### CROSS REFERENCE TO RELATED APPLICATIONS

This application claims benefit of provisional application 60/572,042, May 18, 2004, which is incorporated by reference herein in its entirety.

### BACKGROUND OF THE INVENTION

1. Field of the Invention

The present invention is directed to a method, device, and computer readable storage medium for generating targeted advertisements in an anonymous environment.

2. Description of the Related Art

Anonymous proxy servers are used so that a web surfer can surf the web anonymously.

What is needed is an improved method for generating advertisements for these surfers, so that a web surfer can click on a targeted advertisement (or other content) and still continue to surf anonymously.

### SUMMARY OF THE INVENTION

It is an aspect of the present invention to provide a method to generate targeted advertisements and/or other targeted content in (but not requiring) and an anonymous environment.

The above aspects can be obtained by a method that includes: (a) capturing words on a web page currently being visited; and (b) generating a targeted content based on the words.

The above aspects can also be obtained by a method that includes (a) capturing words on a currently visited URL; and (b) generating a targeted content based on the words.

The above aspects can also be obtained by a method that includes (a) retrieving a web page for a user anonymously; (b) capturing keywords relating to the user's web use; (c) generating advertisements based on the keywords; (d) displaying the generated advertisements with links for an anonymous server so that the user can visit sites of the advertisements anonymously.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 illustrates an example of an anonymous web server environment;

FIG. 2 illustrates an example search engine output screen, according to an embodiment; and

FIG. 3 illustrates an exemplary flowchart to implement a method of generating targeted advertisements, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

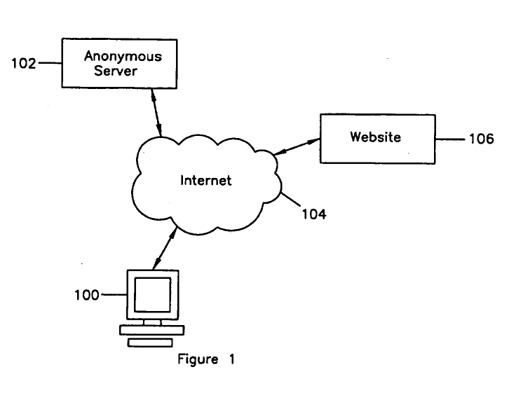

FIG. 1 illustrates an example of an anonymous web server environment, according to an embodiment.

A remote computer 100 can be connected to a computer communications network such as the internet 104. The remote computer 100 can visit an anonymous server 102 and specify a URL. The anonymous server 102 in turn requests a page from a web site 106 (corresponding to the URL), which is then transmitted back to the anonymous server 102. The anonymous server 102 then transmits the web page back to the remote computer 100. In this manner, the remote computer's IP address does not need to be known by any site but the anonymous server 102 itself.

Search engines can also be implemented in an anonymous environment. A party can search the web, then click a resulting link, although through an anonymous server, such that the user's IP address remains invisible to everything but the anonymous server.

Search engines typically generate advertisements (which can include relevant weblinks) based on keywords used in searching.

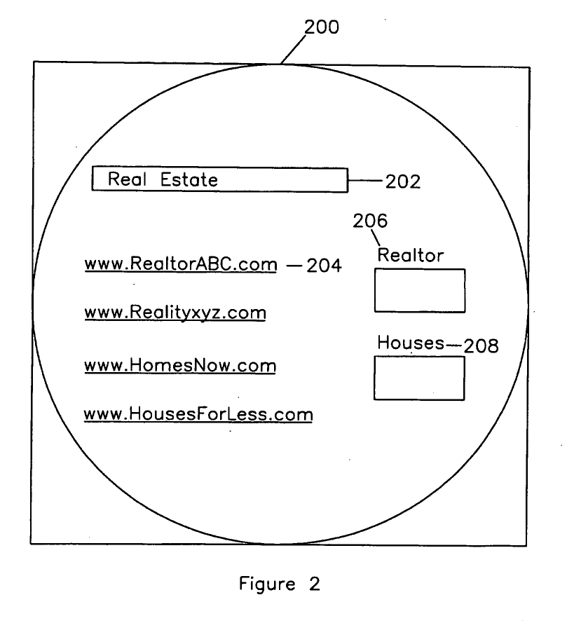

FIG. 2 illustrates an example search engine output screen, according to an embodiment.

An n anonymous search engine output screen 200 is used to search the web and generate advertisements. A text search field 202 can be used to input keywords to search the web. A list of hits 204 is displayed with the most relevant web sites/pages. A first advertisement box 204 and a second advertisement box 208 (an unlimited number of advertisement boxes can be generated) are targeted towards the keyword(s) in the text search field 202. The advertisement boxes contain links to advertisers, however in an embodiment of the present general inventive concept, clicking these advertisers allows the user to visit these sites anonymously. In addition to advertisements, other targeted content can be generated as well (as described herein).

The present general inventive concept can generate a list and or directory of website links (URL's) that can be visited anonymously. The list can be generated based on a key word or phrase input by a user in a www.keyword/phrase.com format. These keywords input by the user can be used to generate [data mining] a directory/list is directly related to the theme/topic/general information of the phrase/key word to be retrieved.

The method is similar to a synonym or thesaurus type of system, for displaying content, advertising or retail websites. The data mining process can work like the spell check/thesaurus process that MS Word uses, and the novelty of the process/system is that the user (A), is not seen by content provider (C), since the IP anonymity system (B) provides IP privacy. The user may choose to register and participate the ads program through the IP anonymity system (B) partnership program. See diagram below in Table I:

TABLE I

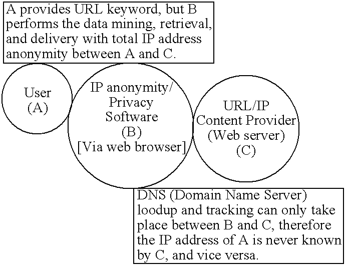

The server of the privacy protection network records the IP address (or http://) of the websites visited by each user when surfing the web. Based on the IP address (or URL i.e. http//www.cnn.com) entered by the user, the server is using data mining methodology to determine the type of website the user is visiting and then assigns similar type of advertisement links (URL's) (i.e. http://www.foxnews.com), or all relevant websites on the user's browser in the form of ads or web links or other relevant content. The web link for all the similar websites (www.foxnews.com) are anonymous and encrypted when accessed.

As a first example, a user types www.book.com in anonymous proxy server, on the side panel of the browser; the anonymous proxy will provide other relevant websites, such as www.amazon.com, www.bn.com, www.bookfinder.com and or www.half.com, etc. (all book store related websites). The novelty is these website are accessed anonymously. (Unknown (anonymity) to C through B for user A).

As another example, when a user types in www.dating.com (on the URL), the browser returns: www.date.com, www.lifepartner.com, www.friendfinder.com, etc. in the form of ads or web links that can all be accessed anonymously by user A. The novelty is, when people click on these intelligently-picked websites (in the form of a directory), these websites are accessed anonymously.

Since all anonymous surfing activities are typically visible under the roof of the anonymous proxy server, data mining can be achieved by monitoring and capturing the inputs and all transactions done by anonymous web users (i.e. keyword, web link, files->all activities). Once data mining and process is completed, the proxy server will then allocating and delivering the matching web links, advertisements, information, and data to the anonymous web user. The activities or transaction mentioned above include clicking on a web link, entering URL, entering text, sending/receiving message, posting/reading article, download and upload all type of files (i.e. text, music, video graphic).

The anonymous intelligent data mining system (AIDS) captures all transactions, all contents, and processes the keyword. The capturing process will continue to all website hierarchies visited by the user as long as the user is surfing within anonymous proxy server environment. The proxy server then assigns a pool of relevant selected advertisements, data links, information to anonymous user in term of email, user prefer communication devices, advertisement/web links insertion to the browser's frame or whatever means.

The data mining system of proxy server will be able to track the surfing habit, and determine what keyword to be processed based on the type of activities. Keyword can also be process based on the frequency of occurrence. The threshold frequency count can be set and configured by the remote anonymous proxy server administrator. Once the threshold frequency count has met the pre-set value, the anonymous intelligent data mining system (A/DS) will assign selected advertisement, data links, web links, programs, information to anonymous web user via of email, and other communication tools, or simply appear on the frame browser.

Content Interpreter System (CIS) work as follows. Once web content is access by a user, CIS from anonymous proxy server will read the third party web content, can scan and captured all transactions in between the third party website and the anonymous user. CIS will search and filter for keywords and save the keyword in the database. The keyword can be recorded and if the keyword is reaching the threshold of frequency count (e.g. 5 or any number), it can trigger the match matching process. CIS can match a relationship for the incoming (keywords encountered by anonymous web users) and keywords in the proxy server's database.

For example, Keyword “love” “flower” “florist” is associate to “flower stores”. Keyword “sick” can be associated to “clinic”; keyword “Barbie” can be associated to “online toy stores.” The source of keyword to be captured and processed could be the target third party website's source code, such as <title>, <meta name>, <link rel> etc. of the source code on the webpage access by user. Based on the source code, the CIS will be able to transport the keyword for data mining process.

For example, table II illustrates exemplary source code of a website with keywords to be captured and processed.

TABLE II
<title>Patent.org :: Attorney services for patents trademarks copy-
rights and related
matters. :: </title>
<meta name=“keywords” content=“patent, lawyer, attorney, California,
trademark,
copyright, dispute, intellectual, property, los angeles,”/>
<meta name=“description” content=“The Law Office of ABC, Registered
Patent
Attorney, a lawyer specializing in patent, trademark, copyright, domain
name
disputes, and other intellectualproperty matters.”/>
<link rel=“alternate” type=“application/rss+xml” title=“RSS”
href=“http://www.patent.org/xml/news.xml”/>

The anonymous intelligent data mining system (AIDS) can assign selected advertisement, data link, information to anonymous web user via email, user preferences communication devices or simply appear on the frame browser or whatever means.

Once anonymous users enter a website, they may bookmark the anonymous web link. The bookmark will save the both actual web link and anonymous web link. It will save in his personal folder in his account or export the bookmark by the mean of txt file, html file, or web link format.

The data mining system of proxy server will scan and capture the keywords saved in bookmark. Based on the info, The anonymous intelligent data mining system will assign selected advertisement, data link, and information to anonymous web user in term of email, user preferences communication tools, or simply appear on the frame browser or other mechanism.

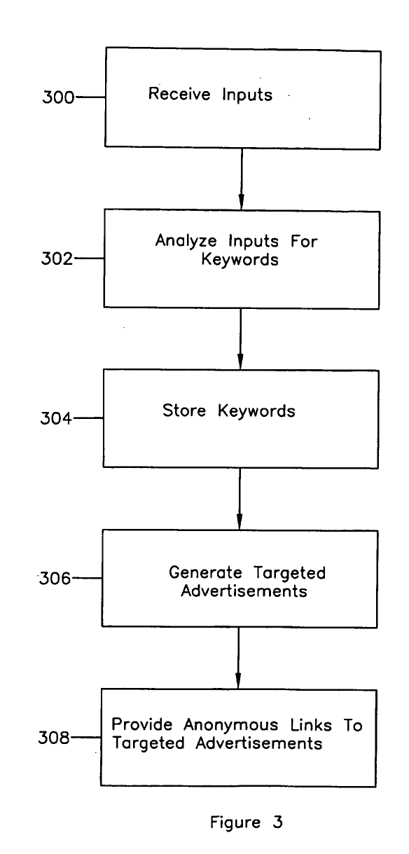

FIG. 3 illustrates an exemplary flowchart to implement a method of generating targeted advertisements, according to an embodiment.

The method can start with operation 300, which receives inputs. The inputs can be received in numerous ways, as described herein. For example, inputs can come from keywords entered into a text field itself; inputs can come from keystrokes typed by a user; inputs can come from characters typed into a web page itself by the user; keywords can come from words displayed on a web page; keywords can come from words spoken in a chat room; and any other text field that the search engine can learn about.

From operation 300, the method can proceed to operation 302, which analyzes the inputs for keywords. Not all words captured may make sense or can be used to generate advertisements, so the words captured are analyzed and matched with pre-stored keywords.

From operation 302, the method can proceed to operation 304, which stores the keywords obtained in operation 302. The keywords can be stored in a database which can be associated with the user that generated the keywords. The user can be identified by his or her IP address or a by a login name (the anonymous web engine may optionally require a login).

From operation 304, the method can proceed to operation 306, which can generate targeted advertisements. In addition or in the alternative to targeted advertisements, operation 306 can also generate other targeted content. Targeted content can include relevant web link(s). Targeted content can also include targeted images, for example if identified keywords are related to birds, images of birds can be displayed. Targeted content can also include targeted sounds, for example if an identified keyword relates to Mozart, then a song by Mozart can be outputted to the user via the user's browser. If an identified keyword relates to a particular genre of computer game, then a demo of that particular genre can be automatically (with or without prompting) presented and downloaded by the user. Keywords can be identified via any of the methods described herein, or any methods known in the art. Targeted content can also include any other type of content known in the art.

Keywords can be retrieved from the database and used to generate advertisements (or other targeted content) as described herein. Keywords can be mapped to particular advertisements, so for example a high frequency keyword(s) (or the highest frequency keyword captured) can generate one of a set of targeted advertisements for that keyword(s). Targeted content may be chosen based on random or sequential known keywords to give the user some variety.

From operation 306, the method can proceed to operation 308, which provides anonymous links to the targeted advertiser sites. Thus, the user remains anonymous to any of the merchants that advertise and are clicked.

It is noted that the operations in FIG. 3 can be performed in any sensible order, and some operations may be optional. For example, operation 304 may not be performed if no recognized keywords are found by the system, but operation 306 can still generate targeted advertisements by retrieving respective keywords stored in the database for the particular user. If operation 304 is not performed, then operation 306 may retrieve a keyword generated from a user's profile, bookmarks, or sources related to the particular user or by default setting. Operation 308 may be replaced by an operation that provided non-anonymous links to the targeted advertisements.

If is noted that the process of identifying and storing keywords (operations 300-304 in this example) take place continuously while under an anonymous environment. The anonymous proxy server can mine for and store the keywords. The data-mining can continue throughout all hierarchies of links visited by the user. The user can be identified by his or her IP address by the anonymous server, and thus continuous activity can be mined through the anonymous server. Note that this is in contrast to a standard search engine, wherein once a user clicks on a delivered link, the contact with the search engine is lost, and thus there is no opportunity to mine data as described herein. Keywords can be mined using any method described or any method known in the art.

Further examples of ways keywords can be obtained will be presented.

Example 01, an anonymous web user is accessing a particular search engine within the anonymous proxy server. The keyword input to the search engine (i.e. dating) will be captured by anonymous proxy server. The data mining system will process the keyword and assign selected advertisement, data link, and information to anonymous user in term of email, user preferences entries, or simply appear on the frame browser or whatever means.

Example 02, an anonymous web user is entering the website address (i.e. www.cnn.com) to the URL field of anonymous browser. The anonymous intelligent data mining system will capture, process the web address info (i.e. www.cnn.com) and assign selected advertisement, data link, and information to anonymous user in term of email, user preferences entries, or simply appear on the frame browser or whatever means.

Example 03, an anonymous web user is accessing www.cnn.com. Later, He clicks on other web links within www.cnn.com (note: Without typing any URL or search keyword.) The anonymous intelligent data mining system, will capture the link info, process the keyword and assign selected advertisement, data link, and information to anonymous user via email, user preferences communication devices or simply appear on the frame browser or whatever means.

Example 04, an anonymous web user is using anonymous chatting, posting article, reading article, download and upload articles, music, graphic and info or email to communicate with others. The anonymous intelligent data mining system (AIDS) will capture all transaction and based on the above info, process the keyword info and assign selected advertisement, promotion, data link, and information to anonymous user in term of email, user preferences entries, or simply appear on the frame browser or whatever means.

Example 05, A threshold cap is set said at three in a proxy server. An anonymous web user is surfing the net by clicking the finance related web link in www.cnn.com. The link can be identified as a finance related link by content in the link itself, content in the displayed pages, or any other method described herein. A moment later, he/she is surf another website (i.e. www.cnbc.com), clicking on the finance related web link again. Later he is surfing amazon.com and click on finance related books. He/Her surfing habit had established as “finance” is the keyword that detected on multiple occasion, and the user has reached the threshold of three before the keyword is established.

Once the finance keyword is detected by the AIDS and has met the set threshold (three), the anonymous proxy server can then send out finance related advertisement (i.e. subscribe to WalStreet Journal) and appear on the browser of anonymous web user. Other targeted content can be sent as well.

Example 06, a web user is sending a romantic email to his/her friend. Based on the keyword matching interpretation conducted by CIS. An online florist advertisement will be sent to him by email, posted on his/her browser or by other communication devices. In this example, data typed by the user is parsed and checked for keywords, which can then be stored in associated with this user.

Example 07, based on the link content, the keyword can be extracted and processed. Table III illustrates URLS and keywords that can be extracted. The URLS can be a current page the user is visiting or links that happen to be on a page that user is visiting (or has visited). Keywords can be extracted from URLS by parsing through the URL character by character looking for strings that match with a pre-stored dictionary. The last word in the URL may or may not be given preference over other words in the URL.

TABLE III

http://www.amazon.com/exec/obidos/tg/detail/-/B0002TP1LC/ref=pd_ir_k/103-

2997909-5098236?v=glance&s=kitchen

(keyword: kitchen)
http://www.kbtoys.eom/Results.html/N/2002/WSSN/ActionFigures (keyword: action

figures)

http://www.kbtoys.com/Results.html/previous_keywords//NsDefault/Playskool(keywo

rd:Playskool)

http://www.utexas.edu/computer/ (keyword:computer)
http://www.kbtoys.com/PromoBuilder.html/promoID/1414/place/agsn?lid=M1_StarW

arsPromo&lpos;=M1

(keyword: StarWar)

Example 08, Table IV below illustrates keywords chosen based on the web content, the keyword can be extracted from the source code and processed.

TABLE IV

<title>Patent.org :: Attorney services for patents trademarks
copyrights and related

matters. :: </title>

<meta name=“keywords” content=“patent, lawyer, attorney,
California, trademark,

copyright, dispute, intellectual”/>

<meta name=“description” content=“The Law Office of ABC,
Registered Patent

Attorney, a lawyer specializing in patent, trademark, copyright, domain
name disputes,
and other intellectual property matters.”/>

<link rel=“alternate” type=“application/rss+xml” title=“RSS”

href=“http://www.patent.org/xml/news.xml”/>

In a further embodiment of the present invention, a URL of a target server, after being processed by the anonymous server, can be encrypted. For example, if a user visits www.cnn.com, the following URL may appear on the user's browser: www.anonymousproxy.com/gethtml.php?_u_r_l=aHR0cDovL3d3dy5jbm4uY29t. A user may be able to view the actual URL by clicking a particular button. The actual URL can then be revealed. The button serves to decrypt the currently displayed URL. The anonymous server can decrypt the URL and serve the actual URL to the user's browser (or alternatively the decryption can be performed on the user side).

When there are transmissions between any of the remote computer, anonymous server, and web site, handshaking between the two computers may take place. For example, machines may transmit information containing machine information, routing data, or other information not directly related to the content being transferred. This data can also be mined for keywords. For example, data exchanged between the remote computer and the web site (via the anonymous server) can include information such as hardware data, web browser being used, screen resolution, etc.

For example, when a remote computer uses an anonymous server to request a web page from the web site, the anonymous server may transmit machine information from the remote computer to the web site. This information may not be required to be transmitted web site but can also remain just between the remote computer and the anonymous server. The anonymous server can capture this machine information and associate with the user's record in a database which stores respective keywords and other usage data. The anonymous server can then use this information in generating targeted content. For example, if the user is using an intel processor, the anonymous server can generate content targeted to an intel processor. For example, the content can be a survey that can pop up and ask the user questions relating to his or her processor (e.g. “are you happy with the current speed of your processor? Do you know your current processor? etc.) The survey answers and respective machine data (or other data the survey was based on) can be tabulated and stored. As a result, a data file can be created with survey results which can include particular machine information (or other data transmitted via handshaking or other transmission).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method to generate targeted content, the method comprising:
capturing words on a web page currently being visited; and
generating a targeted content based on the words.

2. A method as recited in claim 1, wherein the targeted content is a targeted advertisement.

3. A method as recited in claim 1, wherein the targeted content is a targeted downloadable module.

4. A method as recited in claim 1, wherein the targeted content is a targeted image.

5. A method to generate targeted content, the method comprising:
capturing words on a currently visited URL; and
generating a targeted content based on the words.

6. A method as recited in claim 5, wherein the targeted content is a targeted advertisement.

7. A method as recited in claim 5, wherein the targeted content is a targeted downloadable module.

8. A method as recited in claim 5, wherein the targeted content is a targeted image.

9. A method to generate advertisements, the method comprising:
retrieving a web page for a user anonymously;
capturing keywords relating to the user's web use;
generating advertisements based on the keywords;
displaying the generated advertisements with links for an anonymous server so that the user can visit sites of the advertisements anonymously.

10. A method as recited in claim 9, wherein the keywords are captured from keys the user types.

11. A method as recited in claim 9, wherein the keywords are captured from a user's current URL.

12. A method as recited in claim 9, wherein keywords are captured from a chat room.

13. A method as recited in claim 9, wherein keywords are captured from a current page's HTML source code.

14. A method as recited in claim 9, further comprising:
capturing keywords from a list of the user's favorite web sites.

15. A method as recited in claim 9, further comprising:
transferring a list of the user's favorite web sites from a first web browser to a transferred list of favorite web sites to an anonymous web server.

16. A method as recited in claim 9, wherein keywords are captured from a link the user clicks.

17. A method as recited in claim 9, further comprising identifying the user by the user's IP address, wherein respective keywords for the user are associated with the user's IP address.

18. A method as recited in claim 9, further comprising identifying the user by a login code and user profile, wherein respective keywords for the user are associated with the user's login code.

19. A method as recited in claim 9, further comprising:
displaying an encrypted URL in the user's browser; and
clicking a button by the user which triggers decrypting the URL into an unencrypted URL and displaying the unencrypted URL in the user's browser.

20. A method to generate a targeted survey, the method comprising:
retrieving a web page for a user's computer anonymously using an anonymous server;
determining a keyword based on handshaking which contains information about the user's computer;
generating and outputting a survey on the user's computer based on the keyword; and
tabulating results for the survey which include the keyword.
